(19) United States
(12) Patent Application Publication
(10) Pub. No.: US 2005/0278241 A1
(43) Pub. Date: Dec. 15, 2005

(54) Buyer-initiated variable price online auction

(76) Inventor: Scot A. Reader, Boulder, CO (US)

Correspondence Address: Scot A. Reader, Esq., Suite 228, 1320 Pearl Street, Boulder, CO, 80302, US

(21) Appl. No.: 10/864,006

(22) Filed: Jun. 9, 2004

(51) Int. Cl. G06F 17/60; G06F 17/30; G06F 17/00

(52) U.S. Cl. 705/37; 707/100; 707/3

(57) ABSTRACT

A method for conducting a buyer-initiated variable price online auction comprises receiving from a buyer a description of an item; starting an auction for the item; providing the description to a first and a second potential seller; accepting a first and a second bid for the item from the first and the second potential seller, respectively; and ending the auction, whereupon a winner of the auction is automatically determined from among the first and the second potential seller based on an association of the winner with a winning bid automatically determined based on the first and the second bid. Auction result notifications may be automatically provided to the buyer, the winning bidder and bidders who do not win the auction. The buyer may specify a maximum price the buyer is willing to pay for the item. The online auction may be facilitated by a network auction facility in communication with network nodes used by the buyer and potential sellers.

### BACKGROUND OF INVENTION

The present invention relates to computerized processes for transacting in goods and services, and more particularly, to auction-style computerized processes for transacting in goods and services.

Seller-initiated online auctions are known. In such an auction, a seller typically posts on a commercial website, such as ebay.com or auctions.yahoo.com, a written description and images of an item for sale along with terms and conditions for the auction and sale. Auction terms and conditions include, for example, auction start and end time and minimum bid. Sale terms and conditions include, for example, payment options, shipping terms and warranty information. Hosting and running of the auction is typically facilitated by software resident on the auction-capable website. Potential buyers who visit the website during the auction, and whose search criteria match the subject matter of the auction, are typically apprised of the web page where the auction is hosted and have the opportunity to bid on the auctioned item. At the end of the auction, the potential buyer who placed the highest bid is declared the winner of the auction and is obliged to purchase the item from the seller.

While seller-initiated online auctions have proven wildly successful in establishing a global online marketplace, they have not fully exploited the potential of this emerging marketplace. A significant shortcoming of seller-initiated online auctions is that potential buyers are limited to the items offered. Accordingly, potential buyers with specific wants are often left with an unhappy choice of either waiting indefinitely for an item that fully meets their criteria to come up for auction or, alternatively, bidding on a suboptimal substitute at risk that an item better satisfying their criteria may become available soon thereafter.

Buyer-initiated online auctions are also known. In such auctions, a buyer typically posts on a commercial website, such as priceline.com, a fixed price that the buyer willing to pay for a particular item, such as an airline ticket or hotel room. A registered group of potential sellers is typically apprised of the fixed price offer and given the opportunity to accept it during a specified time period, with the buyer being obliged to purchase the item from the first willing seller.

While known buyer-initiated online auctions have filled an additional niche, they too have suffered from certain shortcomings. First, the subject matter of the items on which a buyer can make a purchase offer has been extremely limited. Second, the group of potential sellers apprised of the purchase offer has been extremely limited. Third, the buyer may set a price higher than the price at which one or more of the potential sellers are willing to sell the item, and is therefore not guaranteed to receive the lowest price. In other words, potential sellers are not forced to compete on price.

### SUMMARY OF THE INVENTION

The present invention, in a basic feature, provides a method for conducting a buyer-initiated variable price online auction.

In one aspect, a method for conducting an online auction comprises the steps of receiving from a buyer a description of an item; starting an auction for the item; providing the description to a first and a second potential seller; accepting a first and a second bid for the item from the first and the second potential seller, respectively; and ending the auction a specified time after starting the auction, whereupon a winner of the auction is automatically determined from among the first and the second potential seller based on an association of the winner with a winning bid automatically determined based on the first and the second bid and an auction result notification is automatically provided to the buyer.

In another aspect, a method for conducting an online auction comprises the steps of receiving from a buyer a description of an item and a maximum price; starting an auction for the item; providing to a first and a second potential seller the description and the maximum price; accepting from the first and the second potential seller a first and second bid, respectively, each at or below the maximum price; and ending the auction a specified time after starting the auction, whereupon a winner of the auction is automatically determined from among the first and the second potential seller based on an association of the winner with a winning bid automatically determined based on the first and the second bid.

In another aspect, a method for conducting an online auction comprises the steps of receiving at a network auction facility from a first network node being used by a buyer a description of an item; starting at the network auction facility an auction for the item; providing by the network auction facility to a second network node being used by a first potential seller and a third network node being used by a second potential seller the description; receiving at the network auction facility from the second network node and the third network node a first bid and a second bid, respectively; and ending the auction, whereupon the network auction facility determines a winner of the auction from among the first and the second potential seller based on an association of the winner with a winning bid determined based on the first and the second bid.

These and other aspects of the invention will be better understood by reference to the detailed description of the preferred embodiment, read in conjunction with the drawings briefly described. Of course, the invention is defined by the appended claims.

### BRIEF DESCRIPTION OF THE DRAWINGS

FIG. 1 is a network for conducting a buyer-initiated online auction.

FIG. 2 is a network node for participating in a buyer-initiated on-line auction.

FIG. 3 is a Web auction facility for hosting a buyer-initiated online auction.

FIG. 4 is an item registration Web page for a buyer-initiated online auction.

FIG. 5 is an exemplary auction Web page for a buyer-initiated online auction.

FIG. 6 is an exemplary bid placement Web page for a buyer-initiated online auction.

### DETAILED DESCRIPTION OF THE PREFERRED EMBODIMENT

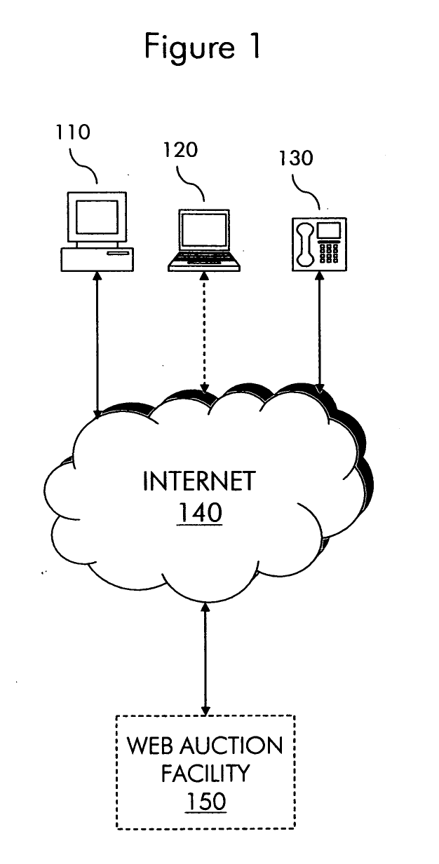

FIG. 1 shows a network for conducting a buyer-initiated online auction. Network nodes 110, 120, 130, which may be personal computers, workstations, personal data assistants (PDAs), Internet phones, and the like, communicate over the Internet 140 with a Web auction facility 150 that hosts an auction-capable website. Communication over Internet 140 is achieved using a standard Internet communication protocol, such as HyperText Transfer Protocol (HTTP), and is facilitated by Web browser applications (not shown), such as Internet Explorer, running on nodes 110, 120, 130, respectively. In operation, human users of nodes 110, 120, 130 specify Web pages at Web auction facility 150 they would like to view by identifying Uniform Resource Locators (URL) to their respective Web browser software applications. The Web browser applications obtain an Internet Protocol (IP) address of Web auction facility 150 from, for example, a domain name service (DNS) (not shown), open connections to Web auction facility 150 and submit Web page requests (e.g., an “HTTP get” messages) to Web auction facility 150. In response to the Web page requests, Web auction facility 150 returns the requested Web pages, typically in the form of text documents in a standard markup language such as HyperText Markup Language (HTML). The Web browser applications display the requested Web pages on the end systems 110, 120, 130.

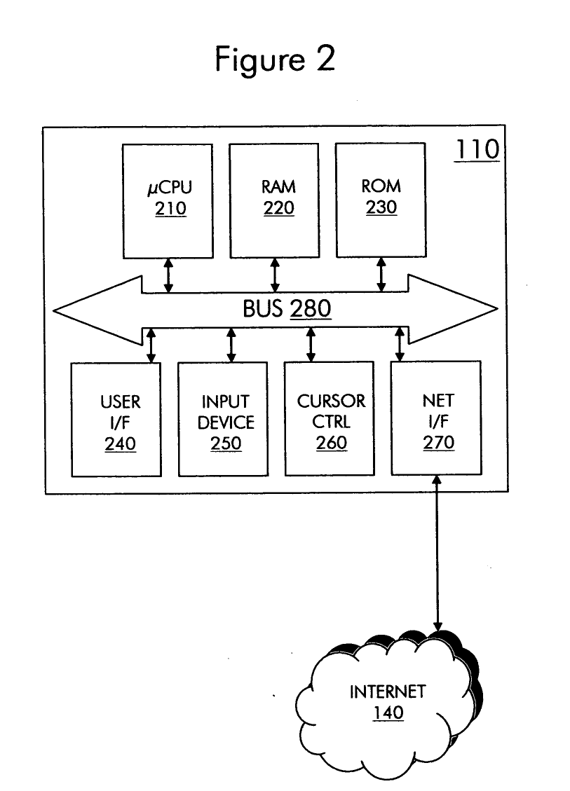

FIG. 2 shows node 110 in greater detail. Node 100 includes a microprocessor 210; a random access memory (RAM) 220; a read only memory (ROM) 230; a user interface 240, for example, a liquid crystal display or a cathode ray tube; an alpha-numeric input device 250, for example, a keyboard or keypad; a cursor control device 260, for example, a mouse or directional keys; and a network interface 270, all of which are interconnected on a bus 280. RAM 220 has stored thereon a Web browser application, such as the above-mentioned Internet Explorer. Microprocessor 210 executes instructions provided by the Web browser application and a connection is established, via network interface 270 and Internet 140, to Web auction facility 150. Information relating to a buyer-initiated auction may then be advantageously exchanged with Web auction facility 150.

Information is exchanged on the established connection in discrete information units which may be formatted according to any of various data link layer and network layer protocols, for example, Ethernet, IP, MPLS (Multiprotocol Label Switching), ATM (Asynchronous Transfer Mode) and Frame Relay. The discrete information units may traverse any number of multiplexing nodes, for example, switches and routers, en route between node 110 and Web auction facility 150. Although node 110 is shown directly connected to Internet 140, it should be appreciated that node 110 may be indirectly connected to Internet 140 via a multi-node home network or enterprise network, for example. Additionally, node 110 may be connected to Internet 140 via a wired connection, such as a dialup phone connection or wired Ethernet connection, or a wireless connection, such as a cellular telephone connection or wireless Ethernet connection.

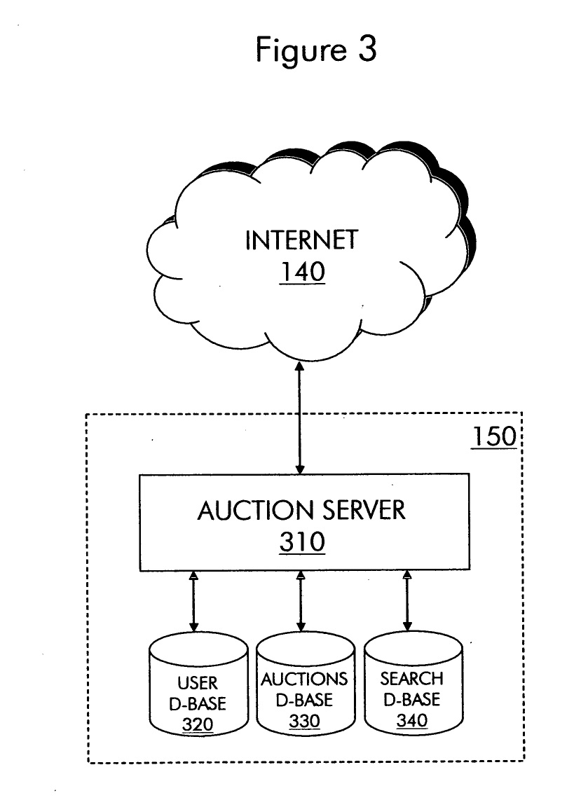

FIG. 3 shows Web auction facility 150 in more detail. Facility 150 includes an auction server 310 which has access to a user database 320, an auction database 330 and a search database 340. Auction server 310 includes one or more microprocessors (not shown) running an auction management software application (not shown) which will be described in greater detail.

User database 320 stores personal and auction identification information for each user of facility 150. Personal information includes user information and contact information. User information includes a username and password. Contact information includes a mailing address and an email address. Auction identification information includes an alpha-numeric identifier assigned to each auction presently hosted by facility 150 in which the user has expressed interest. This includes auctions for which the user is the potential buyer (i.e. auctioneer), potential seller (i.e. bidder) and a mere observer.

Auctions database 330 stores auction details for each auction presently hosted by facility 150. Auction details include auction identification information, auction status information and a bid history. Auction status information includes a title and written description of the item being auctioned; a maximum bid (i.e. maximum purchase price), if any, for the item; an auction start time; an auction duration; payment options for the item; shipping terms for the item; and special instructions, if any, for the item. The bid history includes a username and a bid amount for each bid that has been placed on the item.

Search database 340 stores search and auction identification information for each auction presently hosted by facility 150. Search information includes search elements. Search elements include keywords extracted from the title of the item being auctioned.

In a preferred embodiment, conducting a buyer-initiated online auction within the network of FIG. 1 involves three basic steps: item registration; auction; and result determination.

Item Registration

When a user on a network node, for example, node 110, determines an item the user wants to purchase by way of an online auction, the user registers the item with facility 150. Particularly, the user, via the Web browser on node 110, connects to the home page of facility 150, which is rendered by auction server 310. The home page, when displayed on node 110, includes a selectable HTML interface element, which may be in the form of a checkbox, radio button or an option on a pull-down menu, for example. The selectable HTML interface element indicates to the user that, if selected, the user will be prompted to specify terms and conditions for an auction and purchase of an item for which the user is the potential buyer. In a simple example, the selectable HTML interface element may be a radio button that reads “Buy.” When the interface element is selected, auction server 310 directs the user to a second Web page that presents the user with a logon prompt and an instruction to logon. The user inputs a username and password, which auction server 310 verifies by resort to user database 320. Upon authenticating the user, auction server 310 directs the user to a third web page, namely, an item registration Web page. The item registration Web page includes an HTML registration form into which the user, as the potential buyer of an item, or auctioneer, sets the terms and conditions for auction and purchase.

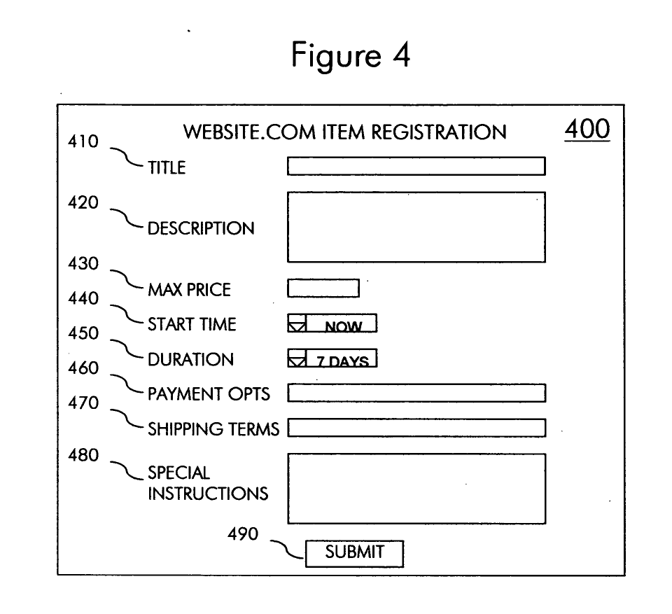

FIG. 4 shows an item registration Web page 400 for a buyer-initiated online auction. Page 400 includes a title field 410 for specifying the title of the item sought by the user. Page 400 further includes a description field 420 for specifying a detailed written description of the item. Page 400 further includes a maximum price field 430 for specifying a maximum amount the buyer is willing to pay for the item. Page 400 further includes a start time pull-down menu 440 and an auction duration pull-down menu 450 for selecting the start time and duration of the auction, respectively. Page 400 further includes a payment options field 460 for specifying how the buyer is willing to pay for the item, a shipping terms field 470 for specifying shipping terms for the item and a special instructions field 480 for specifying the buyer's additional terms and conditions for the auction and purchase, for example, timing of payment, timing of item delivery, packing instructions, warranty terms and geographic or other restrictions on sellers. Finally, page 400 includes a “SUBMIT” button 490.

Naturally, fields 410, 420, 430, 460, 470 may be replaced or supplemented with suitable HTML interface elements, such as checkboxes, radio buttons or pull-down menus to facilitate the item registration process. Additionally, certain of the fields and/or interface elements may have specified default values. For example, start time field 440 may have a default of “NOW”, auction duration field 450 may have a default of “7 DAYS”, shipping terms field 470 may be supplemented with seller and buyer checkboxes with buyer checked as the default, and so on. Moreover, additional information may be required from the buyer, such as identification of one or more general subject matter categories for the item that may be used to facilitate location of the auction by potential sellers. For this, the potential buyer may be required to select a subject matter category from a pull-down menu on page 400. Furthermore, functionality may be included allowing the buyer to upload images of the desired item.

Once the buyer is satisfied with the information specified, the buyer clicks on or otherwise activates “SUBMIT” button 490 to complete item registration. Auction server 310 checks the specified information for completeness and, if complete, assigns an identifier to the auction and stores the auction details in auctions database 330. Auction server 310 further creates, using the identifier, a URL to a common gateway interface (CGI) program stored on auction server 310 which the user and potential sellers can call to have a Web page with current status information on the auction generated and rendered. Auction server 310 further extracts keywords from title field 410 and stores the keywords, full title and CGI URL in search database 340. Finally, auction server 310 retrieves the buyer's email address from user database 320 and notifies node 110 of the CGI URL by sending an email message to the user's email account.

Auction

The auction starts at the time specified on the auction start time menu 440 and ends when the time specified in auction duration menu 450 has elapsed. During the auction, users interested in selling the item (i.e. potential sellers) sought by the user who initiated the auction (i.e. buyer) compete for the right to sell the item to the buyer through a bidding process. For simplicity, bid placement will be described by reference to the actions of a user of node 120, although it will be understood that the users of other nodes, for example node 130, place bids by following the same procedures.

User of node 120 connects to the home page of facility 150, which is rendered by auction server 310. The home page, when displayed on node 120, includes a text field for entry of search keywords. When the user submits keywords, auction server 310 looks up the keywords in search database 340 and finds matching auctions. Auction server 310 renders a Web page displaying the title of each matching auction in the form of a link to the CGI URL for the auction. When the user clicks on or otherwise activates the title link, the CGI URL is activated and a Web page with the current auction details is rendered to the user.

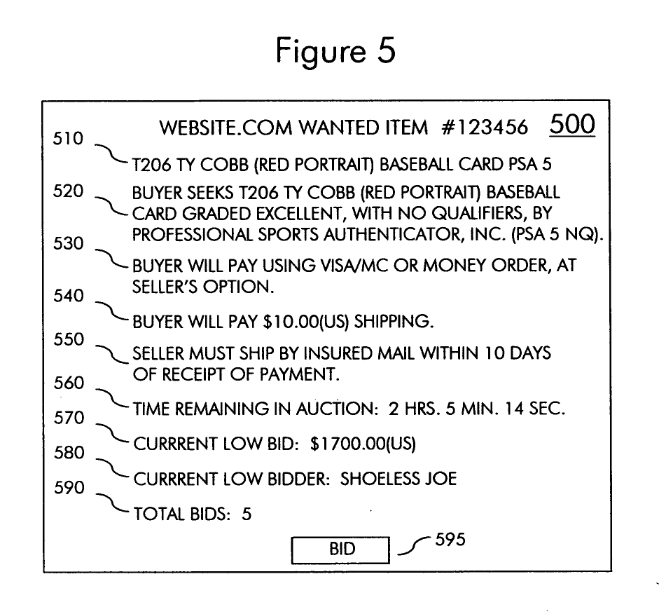

FIG. 5 shows an exemplary auction Web page 500 for a buyer-initiated online auction. Web page 500 presents to the user the current status of the auction. In this example, the auction is for a Ty Cobb baseball card. Page 500 includes an auction title 510 followed by an item description 520. Item description 520 is followed by payment options 530 and shipping terms 540, which are in turn followed by special instructions 550. After special instructions 550 are shown the time remaining in the auction 560, the current low bid 570 and low bidder identity 580, and the total number of bids 590. Finally, page 500 includes a “BID” button 595 allowing the user to compete in the auction as a potential seller by placing a lower bid than the current low bidder. If the user clicks on or otherwise activates the “BID” button, auction server 310 directs the user to a second web page (not shown) which presents the user with a logon prompt and an instruction to logon. The user inputs a usemome and password, which auction server 310 verifies by resort to user database 320. Upon authenticating the user, auction server 310 directs the user to a third web page, namely, a bid placement page, which includes an HTML registration form into which the user, as the potential seller of an item, places a bid for the item.

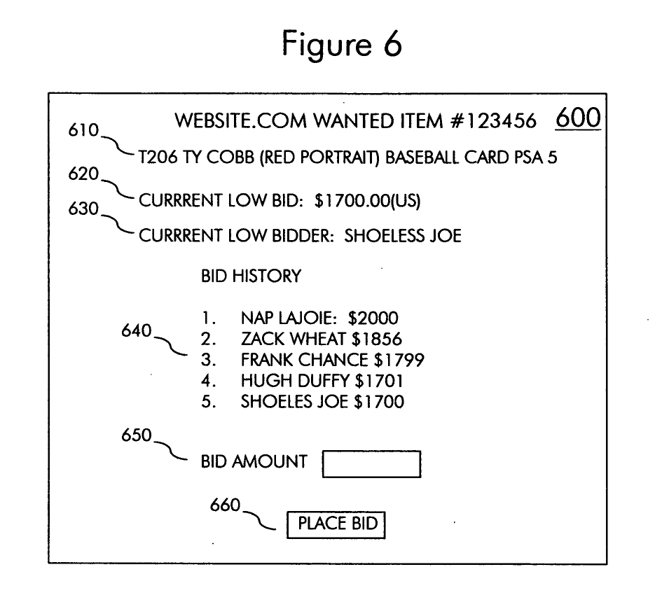

FIG. 6 shows an exemplary bid placement Web page 600 for a buyer-initiated online auction. Page 600 presents to the user a bid history for the auction. Page 600 includes an auction title 610 followed by the current low bid 620 and low bidder 630. Low bidder 630 is followed by a bid history 640 showing previous low bidders. After bid history 640 is a bid amount field 650 and “PLACE BID” button 660. Once the user completes field 650 and is satisfied with the information specified, the user clicks on or otherwise activates “PLACE BID” button 660 to submit the bid. Auction server 310 checks the submitted bid against the bid history in auctions database 330 to ensure that it is lower than the current bid and, if it is, updates the bid history in auctions database 330. Auction server 310 further notifies the user whether the bid has been successfully placed.

In one embodiment, called incremental price bidding, the current bid against which the submitted bid is compared is not necessarily the current low bid identified on page 600 (i.e. $1700). In this embodiment, the current low bid in the auction is an amount that is one bid increment lower than the bid of the second lowest bidder. Thus, in this embodiment, Shoeless Joe may have placed a bid of $1500, but since Hugh Duffy is the next lowest bidder and placed a bid of $1701, and since the bid increment is $1, the current low bid is shown as $1700. Accordingly, for the bid submitted by the user of node 120 to be successfully placed, it would have to be lower than $1500.

In an alternative embodiment, called fixed price bidding, the current bid against which the submitted bid is compared is the current low bid shown on page 600 (i.e. $1700). In this embodiment, the current low bid in the auction is always the amount of the bid placed by the lowest bidder, regardless of the second lowest bid. Thus, in this embodiment, Shoeless Joe placed a bid of $1700, and for the bid submitted by the user of node 120 to be successfully placed it must be lower than $1700.

At the end of the auction, the current low bid becomes the final low bid and the current low bidder becomes the seller. As described in the preceding two paragraphs, the current low bid is either an amount that is one bid increment lower than the bid of the second lowest bidder in an incremental price bidding context, or the lowest bidder's bid in a fixed price bidding context.

Result Notification

At the end of the auction, auction server 310 retrieves the bid history for the auction from auctions database 330 and determines the seller's username through association with the final low bid. Auction server 310 uses the seller's username to retrieve the seller's email address from user database 320. Auction server 310 further uses the buyer's usemome to retrieve the buyer's email address from user database 320. Auction server 310 then notifies node 120 being used by seller of the auction result by sending an email message to their seller's email account, and notifies node 110 being used by buyer of the auction result by sending an email message. The email message sent to the seller includes at least a congratulatory message, the buyer's email address, and a CGI URL which the seller can call to have a Web page with final status information on the auction generated and rendered. The email message sent to the buyer includes at least a congratulatory message, the seller's email address, and a CGI URL which the buyer can call to have a Web page with final status information on the auction generated and rendered. The Web page with final status information may, for example, be an updated version of auction Web page 500 in which current low bid 570 and low bidder identity 580 are replaced with a winning bid and winning bidder identity, respectively, and in which “BID” button 595 is replaced with the buyer's and the seller's email addresses. Other bidders on the item who did not place the final low bid (e.g. Shoeless Joe) may be notified by email that they did not win the auction in a similar manner. Naturally, no congratulatory message would be included in such third party auction result notifications.

It will be appreciated by those of ordinary skill in the art that the invention may be embodied in other specific forms without departing from the spirit or essential character hereof. The present invention is therefore considered in all respects to be illustrative and not restrictive. The scope of the invention is defined by the appended claims, and all changes that come within the meaning and range of equivalents thereof are intended to be embraced therein.

1. A method for conducting an online auction, comprising the steps of:
receiving from a buyer a description of an item;
starting an auction for the item;
providing the description to a first and a second potential seller;
accepting a first and a second bid for the item from the first and the second potential seller, respectively; and
ending the auction a specified time after starting the auction, whereupon a winner of the auction is automatically determined from among the first and the second potential seller based on an association of the winner with a winning bid automatically determined based on the first and the second bid and a first auction result notification is automatically provided to the buyer.

2. The method of claim 1, wherein the winning bid is an automatically determined amount of a lower bid among the first and the second bid.

3. The method of claim 1, wherein the winning bid is an automatically determined amount that is an increment lower than a higher bid among the first and the second bid.

4. The method of claim 1, further comprising the steps of receiving from the buyer a maximum price and providing the maximum price to the first and the second potential seller.

5. The method of claim 1, wherein a second auction result notification is automatically provided to the winner.

6. The method of claim 1, wherein a third auction result notification is automatically provided to the one among the first and the second potential seller who is not the winner.

7. The method of claim 1, wherein the first and the second bid represent amounts for which the first and the second potential seller, respectively, declare a willingness to sell the item to the buyer.

8. A method for conducting an online auction, comprising the steps of:
receiving from a buyer a description of an item and a maximum price;
starting an auction for the item;
providing to a first and a second potential seller the description and the maximum price;
accepting from the first and the second potential seller a first and second bid, respectively, each at or below the maximum price; and
ending the auction a specified time after starting the auction, whereupon a winner of the auction is automatically determined from among the first and the second potential seller based on an association of the winner with a winning bid automatically determined based on the first and the second bid.

9. The method of claim 8, wherein the winning bid is an automatically determined amount of a lower bid among the first and the second bid.

10. The method of claim 8, wherein the winning bid is an automatically determined amount that is an increment lower than a higher bid among the first and the second bid.

11. The method of claim 8, wherein an auction result notification is automatically provided to the buyer.

12. The method of claim 8, wherein an auction result notification is automatically provided to the winner.

13. The method of claim 8, wherein an auction result notification is automatically provided to the one among the first and the second potential seller who is not the winner.

14. The method of claim 8, wherein the first and the second bid represent amounts for which the first and the second potential seller, respectively, declare a willingness to sell the item to the buyer.

15. The method of claim 8, wherein the maximum price represents a maximum amount for which the buyer declares a willingness to purchase the item from a seller.

16. A method for conducting an online auction, comprising the steps of:
receiving at a network auction facility from a first network node being used by a buyer a description of an item;
starting at the network auction facility an auction for the item;
transmitting by the network auction facility to a second network node being used by a first potential seller and a third network node being used by a second potential seller the description;
receiving at the network auction facility from the second network node and the third network node a first bid and a second bid, respectively; and
ending the auction, whereupon the network auction facility determines a winner of the auction from among the first and the second potential seller based on an association of the winner with a winning bid determined based on the first and the second bid.

17. The method of claim 16, wherein the winning bid is a determined amount of a lower bid among the first and the second bid.

18. The method of claim 16, wherein the winning bid is a determined amount that is an increment lower than a higher bid among the first and the second bid.

19. The method of claim 16, wherein the network auction facility transmits an auction result notification to the buyer.

20. The method of claim 16, wherein the network auction facility transmits an auction result notification to the winner.

21. The method of claim 16, wherein the network auction facility transmits an auction result notification to the one among the first and the second potential seller who is not the winner.

22. The method of claim 16, further comprising the steps of receiving from the first network node a maximum price and transmitting to the second and the third network node the maximum price.

23. The method of claim 16, wherein the first and the second bid represent amounts for which the first and the second potential seller, respectively, declare a willingness to sell the item to the buyer.

24. The method of claim 22, wherein the maximum price represents a maximum amount for which the buyer declares a willingness to purchase the item from a seller.
